(19) United States
(12) Patent Application Publication
(10) Pub. No.: US 2026/0298956 A1
(43) Pub. Date: Oct. 1, 2026

(54) AUTOMATIC ANALYZING APPARATUS

(71) Applicant: Canon Medical Systems Corporation, Otawara-shi (JP)

(72) Inventors: Mana KATO, Tokyo (JP); Shozo HASHIMOTO, Tokyo (JP); Yoshifumi YAMAGATA, Sakura (JP); Tomoaki KURANO, Nasushiobara (JP); Shoichi KITA, Yokohama (JP); Takahiro OMORI, Otawara (JP); Hideto KOJIMA, Nikko (JP)

(73) Assignee: Canon Medical Systems Corporation, Otawara-shi (JP)

(21) Appl. No.: 19/570,800

(22) Filed: Mar. 18, 2026

(30) Foreign Application Priority Data
Mar. 27, 2025 (JP) 2025-054514

(51) Int. Cl. G01N 35/00; G01N 35/04; G01N 35/10

(52) U.S. Cl. CPC G01N 35/00732; G01N 35/04; G01N 35/1002; G01N 35/1065; G01N 2035/00801; G01N 2035/0443; G01N 2035/0453

(57) ABSTRACT

According to one embodiment, an automatic analyzing apparatus includes a plurality of reagent storage parts configured to hold reagent containers and arranged at different positions in a vertical direction. A respective one of the plurality of reagent storage parts includes an overlapping region overlapping another one of the reagent storage parts in the vertical direction.

### CROSS-REFERENCE TO RELATED APPLICATION(S)

This application is based upon and claims the benefit of priority from Japanese Patent Application No. 2025-054514, filed Mar. 27, 2025, the entire contents of which are incorporated herein by reference.

### FIELD

Embodiments described herein relate generally to an automatic analyzing apparatus.

### BACKGROUND

With an automatic analyzing apparatus for clinical examination, a certain amount of a biological specimen (hereinafter, simply referred to as a “specimen”) such as blood or urine, and a certain amount of a reagent are mixed and reacted to obtain a mixed liquid, and a quality of light is measured by irradiating the mixed liquid with transmitted light or scattered light, and in this manner, a concentration of a substance to be measured, an activity value, a time required for change, etc., are determined. The automatic analyzing apparatus includes a reagent storage part (reagent depository) configured to store a reagent bottle having a reagent stored therein.

Conventionally, in order to secure the number of reagent containers to be stored in the reagent storage part, for example, an outer circumferential row of reagent containers in which the reagent containers are arranged in an annular shape and an inner circumferential row of reagent containers in which a plurality of reagent containers are arranged in an annular shape have been formed in a single reagent storage part. Alternatively, two reagent depositories each having a plurality of reagent containers arranged in an annular shape are arranged at different positions on the same plane. With such a configuration, the diameter and footprint of the reagent storage part undesirably increase, thereby leading to a concern that a limited space in an examination room will be taken up. Therefore, it is required that a reagent storage part be decreased in size while securing the amount of reagent storable in the reagent storage part.

### BRIEF DESCRIPTION OF THE DRAWINGS

FIG. 1 is a diagram showing a configuration of an automatic analyzing apparatus according to an embodiment.

FIG. 2 is a diagram showing a configuration of an analysis mechanism according to the embodiment.

FIG. 3 is a diagram showing a configuration of a reagent depository according to the embodiment.

FIG. 4 is a diagram showing a state of dispensing according to the embodiment.

FIG. 5 is a diagram showing a configuration of an automatic reading mechanism according to the embodiment.

FIG. 6 is a diagram showing a state in which reading is performed by the automatic reading mechanism in FIG. 5.

FIG. 7 is a diagram showing a modification of the automatic reading mechanism.

FIG. 8 is a diagram showing a state in which reading is performed by the automatic reading mechanism in FIG. 7.

FIG. 9 is a diagram showing a state in which reading is performed by the automatic reading mechanism in FIG. 7.

FIG. 10 is a diagram showing a modification of the automatic reading mechanism.

FIG. 11 is a diagram showing a modification of the automatic reading mechanism.

FIG. 12 is a diagram showing a modification of the automatic reading mechanism.

FIG. 13 is a diagram showing a modification of the automatic reading mechanism.

FIG. 14 is a diagram showing a modification of an arrangement of the reagent depository.

FIG. 15 is a diagram showing a modification of the arrangement of the reagent depository.

FIG. 16 is a diagram showing a modification of the arrangement of the reagent depository.

FIG. 17 is a diagram showing a modification of the arrangement of the reagent depository.

FIG. 18 is a diagram showing a modification of the arrangement of the reagent depository.

FIG. 19 is a diagram showing a modification of the arrangement of the reagent depository.

FIG. 20 is a diagram showing a modification of the arrangement of the reagent depository.

FIG. 21 is a diagram showing a modification of the arrangement of the reagent depository.

FIG. 22 is a diagram showing a modification of the arrangement of the reagent depository.

FIG. 23 is a diagram showing a modification of the arrangement of the reagent depository.

FIG. 24 is a diagram showing a modification of the arrangement of the reagent storage.

FIG. 25 is a diagram showing a modification of the arrangement of the reagent storage.

FIG. 26 is a diagram showing a modification of dispensing means.

### DETAILED DESCRIPTION

According to one embodiment, an automatic analyzing apparatus includes a plurality of reagent storage parts configured to hold reagent containers and arranged at different positions in a vertical direction. A respective one of the plurality of reagent storage parts includes an overlapping region overlapping another one of the reagent storage parts in the vertical direction.

Hereinafter, embodiments of an automatic analyzing apparatus will be described in detail with reference to the drawings. In the following description, structural elements having approximately the same function and configuration will be assigned the same reference symbol, and a repeat description will be given only where necessary.

### Embodiment

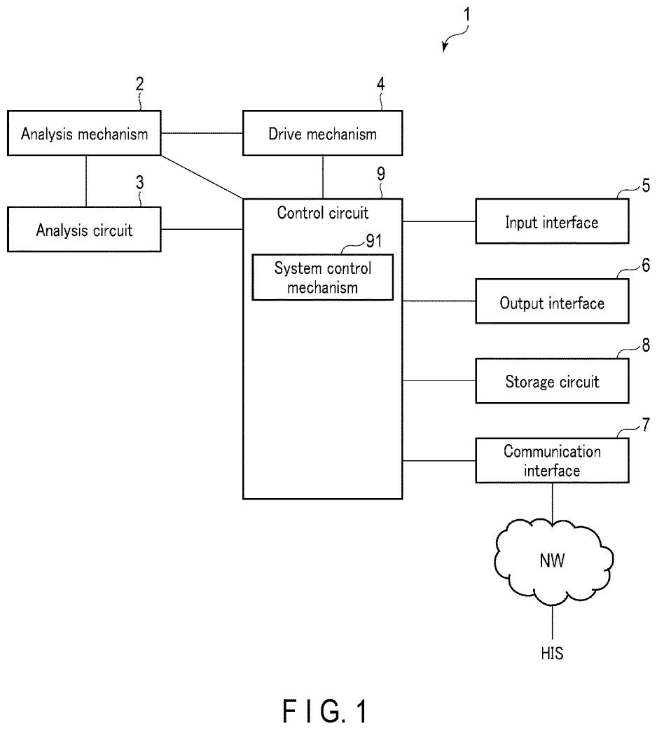

FIG. 1 is a block diagram showing an example of a configuration of an automatic analyzing apparatus 1 according to an embodiment. As shown in FIG. 1, the automatic analyzing apparatus 1 includes an analysis mechanism 2, an analysis circuit 3, a drive mechanism 4, an input interface 5, an output interface 6, a communication interface 7, a storage circuit 8, and a control circuit 9. Meanwhile, the control circuit may also be referred to as a “processing circuit”.

The analysis mechanism 2 mixes a sample, such as a standard sample or a subject sample, with a reagent for use in each test item set for the aforementioned sample. The analysis mechanism 2 measures the mixed liquid of the sample and the reagent to generate standard data and subject data associated with, for example, an absorbency level. In addition, the analysis mechanism 2 measures the mixed liquid of the sample and the reagent to generate standard data and subject data associated with, for example, an electrode potential.

The analysis circuit 3 is a processor configured to analyze the generated standard data and subject data to generate calibration data, analysis data, etc. The analysis circuit 3 reads an operation program from the storage circuit 8 and generates the calibration data, the analysis data, etc., according to the read analysis program. Here, the calibration data is indicative of, for example, a relationship between the standard data and a standard value predetermined for the standard sample, and the analysis circuit 3 generates the calibration data based on the standard data. Also, the analysis circuit 3 generates the analysis data based on the subject data and the calibration data for the test item corresponding to the aforementioned subject data. The analysis data includes, e.g., data in which a concentration value and an activity value of an enzyme are associated with each other, and data in which a concentration of a desired ion in a sample is recorded in time series. The analysis circuit 3 outputs the generated calibration data and analysis data, etc., to the control circuit 9.

The drive mechanism 4 drives the analysis mechanism 2 under the control of the control circuit 9. The drive mechanism 4 is realized by, for example, a gear, a stepping motor, a belt conveyor, and a lead screw. For example, the drive mechanism 4 rotates a reaction disk 201 to be described later at a predetermined rotation angle. The predetermined rotation angle is, for example, an angle of rotation in one cycle.

The input interface 5 accepts, for example, setting of analysis parameters, etc., for each test item intended for a measurement-requested sample via an in-hospital network NW through an operator's operation. The input interface 5 is realized by, for example, one or more of a mouse, a keyboard, a touch pad on which instructions are input by touching an operation screen, and the like. The input interface 5 is connected to the control circuit 9 so that it converts operational commands input by an operator into electric signals and outputs them to the control circuit 9. In this disclosure, the input interface 5 is not limited to physical operating components such as a mouse and a keyboard. Examples of the input interface 5 also include a processing circuit which is configured to receive an electric signal corresponding to an operational command input from an external input device separate from the automatic analyzing apparatus 1, and to output this electric signal to the control circuit 9.

The output interface 6 is connected to the control circuit 9 and outputs signals supplied from the control circuit 9. The output interface 6 is realized by, for example, one or more of display circuits, a print circuit, an audio device, and the like.

Such a display circuit may include, for example, a CRT display, a liquid crystal display, an organic EL display, an LED display, a plasma display, etc. Furthermore, the display circuit may be a processing circuit configured to convert data indicative of a display target into a video signal and externally output the video signal. Examples of the print circuit include a printer, etc. The print circuit may also be an output circuit configured to externally output data indicative of a print target. Examples of the audio device include a speaker, etc. The audio device may also be an output circuit configured to externally output an audio signal.

The communication interface 7 is connected to, for example, the in-hospital network NW. The communication interface 7 performs data communication with a hospital information system (HIS) via the in-hospital network NW. The communication interface 7 may perform data communication with the HIS via a laboratory information system connected to the in-hospital network NW.

The storage circuit 8 stores, e.g., a program to be executed by the control circuit 9 and various types of data for use in processing by the control circuit 9. Such a program may be installed in advance in a computer from a network or a non-transitory computer-readable storage medium, for example, so that the program will cause the computer to realize the respective functions of the control circuit 9. Various types of data handled in this disclosure are typically digital data. The storage circuit 8 is an example of storage means.

The storage circuit 8 stores, e.g., a test order input by an operator or a test order received by the communication interface 7 via the in-hospital network NW. Order information includes a sample ID, a test item required for a sample to be measured, and a measurement order relating to a test. Furthermore, the storage circuit 8 stores various values set such that a series of actions of each component of the automatic analyzing apparatus 1 is executed in one cycle.

The control circuit 9 is, for example, a processor functioning as a center of the automatic analyzing apparatus 1. The control circuit 9 executes a program read from the storage circuit 8, thereby executing a system control function 91. Through the system control function 91, the control circuit 9 takes total control over the components of the automatic analyzing apparatus 1 based on input information input via the input interface 5. For example, the control circuit 9 with the system control function 91 drives the drive mechanism 4 so that measurement operations are conducted according to test items, and controls the analysis circuit 3 to analyze the standard data and the subject data generated by the analysis mechanism 2. The control circuit 9 that realizes the system control function 91 is an example of the controller.

The term “processor” used herein refers to, for example, a central processing unit (CPU) or a graphics processing unit (GPU), or a circuit such as an application-specific integrated circuit (ASIC), a programmable logic device (such as a simple programmable logic device (SPLD)), a complex programmable logic device (CPLD), a field programmable gate array (FPGA)), etc. In a case of the processor being a CPU, for example, the processor realizes a function by reading and executing a program stored in a storage circuit 8. On the other hand, in a case of the processor being an ASIC, instead of a program being stored in the storage circuit 8, a corresponding function is directly incorporated as a logic circuit in the circuit of the processor. Each processor of the present embodiment is not limited to a configuration as a single circuit; a plurality of independent circuits may be combined into one processor to realize the function of the processor. Furthermore, a plurality of structural elements as given in FIG. 1 may be integrated as one processor to realize the respective functions. The above description of the “processor” is applicable to the subsequent embodiments and modifications.

The present embodiment will be described assuming that a single processor realizes each function; however, the embodiment is not limited to such a configuration. For example, a plurality of independent processors may be combined to form a control circuit, and each of the processors may implement a corresponding program to realize each function. Furthermore, the system control function 91 may be called a system control circuit and may be implemented as an individual hardware circuit. The above description of each function executed by the control circuit 9 is applicable to the subsequent embodiments and modifications. The control circuit 9 may be provided with a storage area for storing at least a portion of the data stored in the storage circuit 8. The control circuit 9 may be called a “controller” or a “processing circuit”.

Next, a configuration of the analysis mechanism 2 will be described in detail.

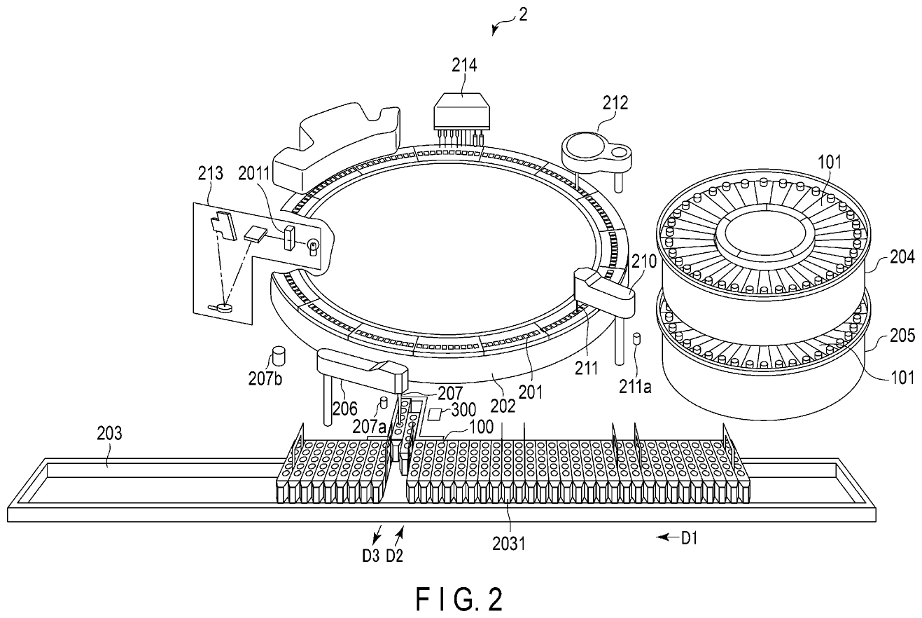

FIG. 2 is a diagram showing an example of a configuration of the analysis mechanism 2 shown in FIG. 1. As shown in FIG. 2, the analysis mechanism 2 includes a reaction disk 201, a constant temperature part 202, a rack sampler 203, an upper reagent depository 204, and a lower reagent depository 205. Furthermore, the analysis mechanism 2 includes a sample dispensing arm 206, a sample dispensing probe 207, a washing bath 207a, a detergent storage container 207b, a reagent dispensing arm 210, a reagent dispensing probe 211, a washing bath 211a, an electrode unit 212, a photometry unit 213, and a washing unit 214.

The reaction disk 201 holds a plurality of reaction tubes 2011 arranged in an annular shape. The reaction disk 201 is turned and stopped in an alternating manner by the drive mechanism 4, and this alternating motion may be repeated at regular time intervals, e.g., every 4.5 seconds (hereinafter, each time interval will be called “one cycle”). Each reaction tube 2011 is formed of, for example, a glass material, a polypropylene (PP) material, or an acrylic material. Each reaction tube 2011 may be called a “reaction container” or a “cell”. Also, the operation of the reaction disk 201 during a test procedure may be called a “cycle operation”.

The constant temperature part 202 is a container that stores water (constant temperature water) kept at a predetermined temperature (normally, 37° C.). In one example, such constant temperature water contains an additive for anti-bacterial purposes. In the constant temperature part 202, the reaction tubes 2011 are immersed in the stored constant temperature water so that the temperature of a liquid (for example, a mixed liquid) contained in each reaction tube 2011 is warmed and kept at a constant temperature.

The rack sampler 203 holds sample racks 2031 each adapted to hold a plurality of sample containers 100 containing measurement-requested samples in such a manner that the sample racks 2031 can move. FIG. 2 shows an example in which the sample racks 2031 are each capable of holding a row of five sample containers 100.

The rack sampler 203 has a reader 300. The reader 300 is provided at a position at which, for example, an optical mark given to the sample container 100 can be read. The optical mark is a mark obtained by encoding identification information, etc., of a sample contained in the sample container 100, such as, e.g., a bar code, a one-dimensional pixel code, or a two-dimensional pixel code. In response to an instruction for starting ID reading from the control circuit 9, the reader 300 starts reading the optical mark. Upon arrival of the sample container 100 at a position at which its optical mark can be read, the reader 300 reads the identification information of the sample from the optical mark concerned. The reader 300 supplies the read identification information to the control circuit 9. Meanwhile, the reader 300 may be replaced with another sensor using Radio Frequency Identification (RFID), etc.

The rack sampler 203 is provided with a conveyor region in which the sample racks 2031 are conveyed from a feed position for slotting in the sample racks 2031 to a recovery position for collecting the sample racks 2031 that have undergone the measurement operation. In the conveyor region, the multiple sample racks 2031 are arranged with their short sides aligned, and moved in a direction D1 by the drive mechanism 4.

The rack sampler 203 is also provided with a carry-in region in which one or more sample racks 2031 are drawn from the conveyor region so that each of the sample containers 100 held by the sample racks 2031 is moved to a predetermined sample aspirating position. This sample aspirating position is set at, for example, an intersection between the circulating trajectory of the sample dispensing probe 207 to be described later and the moving trajectory of the openings of the sample containers that are held by the sample rack 2031 and supported by the rack sampler 203. In the carry-in region, the incoming sample rack 2031 is moved in a direction D2 by the drive mechanism 4. At a position at which the optical mark in the carry-in region is readable, the optical mark recorded on the sampler container held by the sample rack 2031 that has moved in the direction D2 is read by the reader 300.

The rack sampler 203 is further provided with a carry-back region in which one or more sample racks 2031 holding the sample containers from which the samples have been aspirated are returned to the conveyor region. In the carry-back region, the sample rack 2031 is moved in a direction D3 by the drive mechanism 4.

The sample dispensing arm 206 holds the sample dispensing probe 207 configured to dispense the sample and conveys the sample dispensing probe 207 to a dispensing position. The sample dispensing arm 206 is provided in the vicinity of the reaction disk 201 and the rack sampler 203. The sample dispensing arm 206 is adapted so that it can vertically ascend and descend and also horizontally move through the drive mechanism 4. The sample dispensing arm 206 holds the sample dispensing probe 207 at its one end.

The sample dispensing probe 207 dispenses the sample. In accordance with the sample dispensing arm 206 being horizontally driven, the sample dispensing probe 207 moves within a moving range of the sample dispensing arm 206. This moving range is set so that the openings of the sample containers held by the sample rack 2031 on the rack sampler 203 will be positioned therein.

A first reagent aspirating position is set at a predetermined position on the upper reagent depository 204. A second reagent aspirating position is set at a predetermined position on the lower reagent depository 205. The first and second reagent aspirating positions are set within, for example, a moving range of the reagent dispensing probe 211 to be described later.

The reagent dispensing arm 210 is provided between the reaction disk 201 and the upper and lower reagent depositories 204 and 205. The reagent dispensing arm 210 is adapted so that it can vertically ascend and descend and also horizontally move through the drive mechanism 4. The reagent dispensing arm 210 holds the reagent dispensing probe 211 at its one end.

The reagent dispensing probe 211 moves in accordance with the driving of the reagent dispensing arm 210. The first reagent aspirating position and the second reagent aspirating position are provided in the moving range of the reagent dispensing probe 211. Furthermore, a reagent discharging position for the reagent dispensing probe 211 to discharge an aspirated reagent into the reaction tube 2011 is set in the moving range of the reagent dispensing probe 211.

Yet furthermore, a sample discharging position for the sample dispensing probe 207 to discharge an aspirated sample into the reaction tube 2011 is set in the moving range of the sample dispensing probe 207. The sample discharging position is positioned on the upper side of the moving trajectory of the reaction tube 2011 held by the reaction disk 201.

In the moving range of the sample dispensing probe 207, a washing position at which the sample dispensing probe 207 is washed is provided at a position different from the sample aspirating position and the sample discharging position. The washing position is provided with the washing bath 207a adapted for washing of the sample dispensing probe 207.

In the moving range of the sample dispensing probe 207, a detergent aspirating position for the sample dispensing probe 207 to aspirate detergent may be provided at a position different from the sample discharging position and the washing position. The detergent washing position may be provided with the detergent storage container 207b for storing detergent used to wash an electrode unit to be described later.

By the sample dispensing arm 206 being driven by the drive mechanism 4, the sample dispensing probe 207 moves in an up-down direction at a position directly above the opening of one sample container held by the sample rack 2031 on the rack sampler 203, at the sample discharging position, at the washing position, or the detergent aspirating position.

Under the control of the control circuit 9, the sample dispensing probe 207 aspirates the sample from the opening of the sample container. Also under the control of the control circuit 9, the sample dispensing probe 207 discharges the aspirated sample into the reaction tube 2011 directly below the sample discharging position. The sample dispensing probe 207 performs a series of dispensing actions once in one cycle, for example.

Under the control of the control circuit 9, the sample dispensing probe 207 aspirates washing liquid from the washing bath 207a positioned directly below the washing position on the circulating trajectory of the sample dispensing probe 207. Examples of the washing liquid include pure water, an alkaline detergent for washing a probe, or an acidic detergent for washing a probe. Under the control of the control circuit 9, the sample dispensing probe 207 discharges the aspirated washing liquid into the reaction tube 2011 positioned directly below the sample discharging position. In this manner, the sample dispensing probe 207 and the reaction tube 2011 positioned directly below the sample discharging position are washed. The sample dispensing probe 207 performs a series of washing actions once in one cycle, for example.

Furthermore, in a case where the automatic analyzing apparatus 1 includes the detergent storage container 207b, the sample dispensing probe 207 aspirates, under the control of the control circuit 9, detergent from the detergent storage container 207b positioned directly below the detergent aspirating position on the circulating trajectory of the sample dispensing probe 207. Also under the control of the control circuit 9, the sample dispensing probe 207 discharges the aspirated detergent into the reaction tube 2011 positioned directly below the sample discharging position. The sample dispensing probe 207 performs a series of dispensing actions once in one cycle, for example.

The upper reagent depository 204 is adapted for cold storage of multiple reagent containers 101 storing a first reagent for reaction with a given component in standard samples or subject samples. The upper reagent depository 204 is one example of a first reagent storage part. The upper reagent depository 204 encloses a reagent rack in such a manner that the reagent rack can turn. These reagent racks also hold the plurality of reagent containers 101 arranged in an annular shape. The reagent racks are turned by the drive mechanism 4. The upper reagent depository 204 is arranged at the upper side of the lower reagent depository 205. Each reagent container 101 may be called a “reagent container”.

The lower reagent depository 205 is adapted for cold storage of, for example, reagent containers 101 storing a second reagent constituting a dual-reagent system with the first reagent. The lower reagent depository 205 is one example of a second reagent storage part. The lower reagent depository 205 encloses a reagent rack in such a manner that the reagent rack can turn. These reagent racks also hold the plurality of reagent containers 101 arranged in an annular shape. Note that the second reagent kept at a low temperature in the lower reagent depository 205 may be a reagent of the same components and the same concentration as the first reagent kept at a low temperature in the upper reagent depository 204. The lower reagent depository 205 is arranged at the lower side of the upper reagent depository 204.

Also in the moving range of the reagent dispensing probe 211, a detergent discharging position set for the reagent dispensing probe 211 to discharge aspirated detergent into the reaction tube is set. Also in the moving range of the reagent dispensing probe 211, a washing position at which the reagent dispensing probe 211 is washed is set. Each washing position is provided with the washing bath 211a adapted for washing of the reagent dispensing probe 211.

The reagent dispensing probe 211 is driven by the drive mechanism 4 so that it moves in an up-down direction at the first reagent aspirating position, the second reagent aspirating position, the reagent discharging position, the detergent discharging position, or the washing position.

Under the control of the control circuit 9, the reagent dispensing probe 211 aspirates the first reagent from the reagent container positioned directly below the first reagent aspirating position. Under the control of the control circuit 9, the reagent dispensing probe 211 discharges the aspirated first reagent into the reaction tube 2011 positioned directly below the reagent discharging position. The reagent dispensing probe 211 performs a series of dispensing actions once in one cycle, for example.

Under the control of the control circuit 9, the reagent dispensing probe 211 aspirates the second reagent from the reagent container positioned directly below the second reagent aspirating position. Also under the control of the control circuit 9, the reagent dispensing probe 211 discharges the aspirated second reagent into the reaction tube 2011 positioned directly below the reagent discharging position. The reagent dispensing probe 211 performs a series of dispensing actions once in one cycle, for example.

Under the control of the control circuit 9, the reagent dispensing probe 211 aspirates washing liquid from the washing bath 211a positioned directly below the washing position on the circulating trajectory of the reagent dispensing probe 211. Also under the control of the control circuit 9, the reagent dispensing probe 211 discharges the aspirated washing liquid into the reaction tube 2011 positioned directly below the reagent discharging position. In this manner, the reagent dispensing probe 211 and the reaction tube 2011 positioned directly below the reagent discharging position are washed. The reagent dispensing probe 211 performs a series of washing actions once in one cycle, for example.

The electrode unit 212 measures an electrolyte concentration of the mixed liquid of the sample and the reagent that have been discharged into the reaction tube 2011. The electrode unit 212 includes an ion selective electrode (ISE) and a reference electrode. Under the control of the control circuit 9, the electrode unit 212 measures the electrical potential between the ISE and the reference electrode for the mixed liquid to be measured, thereby detecting the ionic electrolyte (for example, sodium ions, potassium ions, and chloride ions), which are a test item. The electrode unit 212 outputs data on the measured electrical potential, which serves as either the standard data or the subject data, to the analysis circuit 3.

The photometry unit 213 detects the light emitted from the reaction tube 2011 using the photodetector.

Specifically, for example, the photodetector detects light that has passed through the mixture liquid of the standard sample and the reagent in the reaction tube 2011, and generates standard data represented by an absorbency level, etc., based on the intensity of the detected light. Furthermore, the photodetector also detects light that has passed through the mixture liquid of a subject sample and a reagent in the reaction tube 2011, and generates subject data represented by an absorbency level, etc., based on the intensity of the detected light. The photometry unit 213 outputs the generated standard data and subject data to the analysis circuit 3.

The washing unit 214 washes the inside of the reaction tube 2011 for which the measurement of the mixture liquid by the electrode unit 212 or the photometry unit 213 has been completed. The washing unit 214 includes a washing liquid supply pump (not shown) configured to supply a washing liquid for washing the reaction tube 2011. The washing unit 214 also includes a washing nozzle (not shown) configured to discharge the washing liquid supplied from the washing liquid supply pump into the reaction tube 2011 and to aspirate each of the mixture liquid and the washing liquid remaining in the reaction tube 2011.

Furthermore, the analysis mechanism 2 includes a stirring unit (not shown). The stirring unit is provided near the outer circumference of the reaction disk 201. The stirring unit includes a stirring tool, and uses this stirring tool to stir the sample and the first reagent stored in the reaction tube 2011 at a stirring position on the reaction disk 201, or the sample, the first reagent, and the second reagent stored in the reaction tube 2011.

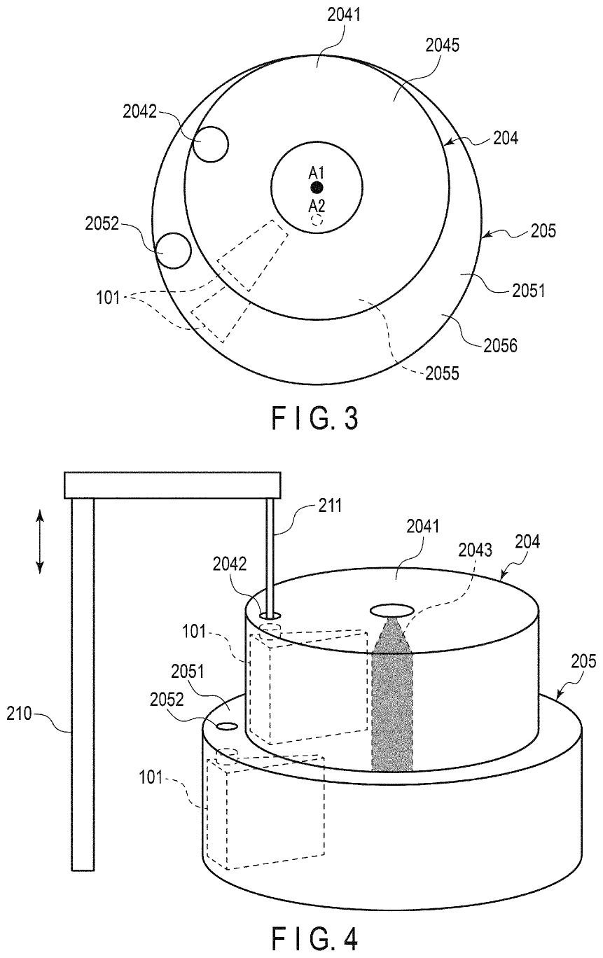

Next, a configuration of the upper reagent depository 204 and the lower reagent depository 205 will be described in detail. FIG. 3 is a diagram showing the upper reagent depository 204 and the lower reagent depository 205 as viewed from above. FIG. 3 shows one of the reagent containers 101 held inside the upper reagent depository 204 and one of the reagent containers 101 held inside the lower reagent depository 205, and omits the other reagent containers 101.

The upper reagent depository 204 includes a reagent cover 2041 configured to cover the reagent containers 101 from above. The reagent cover 2041 is detachably attached to a housing of the upper reagent depository 204. The reagent cover 2041 is provided with an opening 2042 for the reagent dispensing probe 211 to pass therethrough. The opening 2042 is provided at the first reagent aspirating position.

The lower reagent depository 205 includes a reagent cover 2051 configured to cover the reagent containers 101 from above. The reagent cover 2051 is detachably attached to a housing of the lower reagent depository 205. The reagent cover 2051 is provided with an opening 2052 for the reagent dispensing probe 211 to pass therethrough. The opening 2052 is provided at the second reagent aspirating position.

The reagent depository according to the present embodiment is constituted of the upper reagent depository 204 and the lower reagent depository 205, and is arranged to have a two-stage configuration in the vertical direction. With the reagent depository with the two-stage configuration in the vertical direction, the amount of reagent holdable by the entire reagent depository can be secured while decreasing the diameter and footprint of the entire reagent depository.

As described above, in a case where dispensing is performed on the reagent containers 101 inside the upper reagent depository 204 and the lower reagent depository 205 using the reagent dispensing probe 211, the reagent dispensing probe 211 is inserted into the opening 2042 and the opening 2052 from above. Therefore, in a case where the reagent depository has the two-stage configuration constituted of the upper reagent depository 204 and the lower reagent depository 205, it is necessary to prepare a path for the reagent dispensing probe 211 to access the reagent containers 101 held inside the lower reagent depository 205.

In the present embodiment, the upper reagent depository 204 is made smaller in diameter than the lower reagent depository 205 and is arranged inside a region in which the lower reagent depository 205 is arranged in the horizontal direction. For this reason, the lower reagent depository 205 is provided with an overlapping region 2055 that overlaps the upper reagent depository 204 in the vertical direction and a non-overlapping region 2056 that does not overlap the upper reagent depository 204 in the vertical direction. In the present embodiment, the entire region of the upper reagent depository 204 corresponds to the overlapping region 2045 that overlaps the lower reagent depository 205 in the vertical direction. The upper reagent depository 204 is arranged directly above the overlapping region 2055 of the lower reagent depository 205. The non-overlapping region 2056 of the lower reagent depository 205 corresponds to a portion other than the overlapping region 2055, and the upper reagent depository 204 is not arranged directly above the non-overlapping region 2056. Furthermore, by the opening 2052 being provided in the non-overlapping region 2056 of the lower reagent depository 205, the upper reagent depository 204 is arranged such that it does not overlap directly above the opening 2052. Yet further, a center A1 of the upper reagent depository 204 and a center A2 of the lower reagent depository 205 are arranged at different positions.

FIG. 4 is a diagram showing a state of dispensing performed by the reagent dispensing probe 211. FIG. 4 shows one of the reagent containers 101 held inside the upper reagent depository 204 and one of the reagent containers 101 held inside the lower reagent depository 205, and omits the other reagent containers 101. With the configuration described above, the reagent dispensing probe 211 is moved downward from the position directly above the opening 2052 by the driving of the reagent dispensing arm 210 to reach the reagent container 101 inside the lower reagent depository 205 through the opening 2052, thereby being able to aspirate the reagent inside the reagent container 101. That is, the reagent dispensing probe 211 can access the reagent container 101 inside the lower reagent depository 205 without being affected by the operation of the upper reagent depository 204, so that the reagent dispensing probe 211 can perform dispensing on both the upper reagent depository 204 and the lower reagent depository 205.

Furthermore, by arranging the center A1 of the upper reagent depository 204 at a position different from that of the center A2 of the lower reagent depository 205, the upper reagent depository 204 is prevented from overlapping directly above the opening 2052 and the diameter of the upper reagent depository 204 is made as large as possible.

The reagent cover 2041 is provided with an opening (not shown). In a case where the reagent container 101 is stored in the upper reagent depository 204, the reagent container 101 is carried in from the upper side of the upper reagent depository 204 through the opening of the reagent cover 2041. In a case where the reagent container 101 stored in the upper reagent depository 204 is taken out, the reagent container 101 is carried out from the upper reagent depository 204 to the upper side through the opening of the reagent cover 2041. Similarly, the reagent cover 2051 of the lower reagent depository 205 is provided with an opening (not shown), and the reagent container 101 is conveyed through the opening of the reagent cover 2051. In a case of adopting the two-stage configuration constituted of the upper reagent depository 204 and the lower reagent depository 205, the upper reagent depository 204 is arranged on the upper side of the lower reagent depository 205. Thus, it is necessary to secure a path for the reagent container 101 held inside the lower reagent depository 205 to pass therethrough. The reagent containers 101 may be carried in and carried out from the upper reagent depository 204 and the lower reagent depository 205 either automatically or manually.

In the present embodiment, the upper reagent depository 204 is provided with a passage region 2043 through which the reagent containers 101 contained in the lower reagent depository 205 are conveyed. A size of the passage region 2043 is set such that, for example, one reagent container 101 can pass therethrough. The passage region 2043 is a region which is provided in a partial angular range in a circumferential direction of the upper reagent depository 204 and extends outward from the center of the upper reagent depository 204.

No components or structures are arranged in the passage region 2043. In the passage region 2043, the reagent cover 2041 is provided with an opening configured to open upward. Furthermore, in the passage region 2043, the bottom surface of the housing is provided with an opening configured to open downward. Each reagent rack holding each reagent container 101 is provided with an opening formed into the same shape as that of the passage region 2043. In a state in which the opening of the reagent rack has moved to the passage region 2043, a path through which the reagent container 101 can pass through the upper reagent depository 204 in the up-down direction without any obstacle is formed.

The configuration described above enables the reagent containers 101 to be carried out from the inside of the lower reagent depository 205 or to be carried in the inside of the lower reagent depository 205 using the passage region 2043 formed in the upper reagent depository 204. Meanwhile, a size of the passage region 2043 may be set such that two or more reagent containers 101 can pass therethrough.

The lower reagent depository 205 may be configured such that the reagent container 101 is carried in or out from its side. For example, it is preferable that the side surface of the lower reagent depository 205 be provided with an opening through which the reagent containers 101 can pass. In such a case, the reagent container 101 can be carried out or carried in the lower reagent depository 205 from its lateral side, so that the passage region 2043 described above may not be provided.

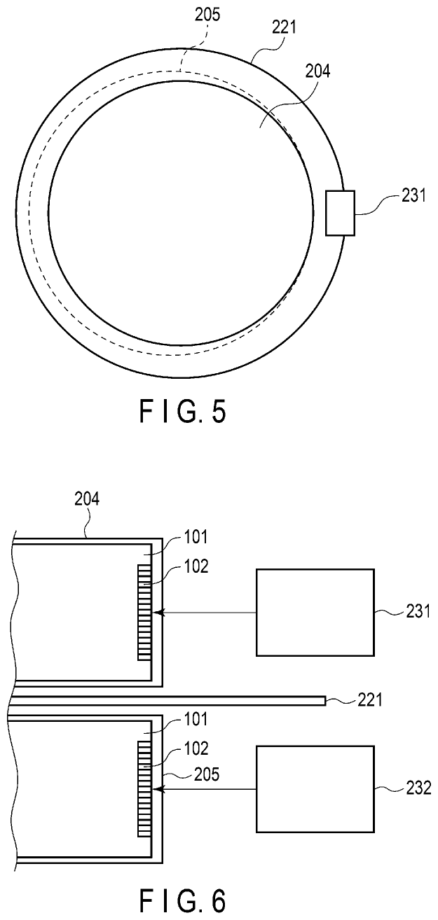

The analysis mechanism 2 includes an automatic reading mechanism that automatically reads a bar code attached to the reagent container 101. FIG. 5 and FIG. 6 are each a diagram showing a configuration of the automatic reading mechanism. FIG. 5 is a diagram showing the upper reagent depository 204, the lower reagent depository 205, and a reader as viewed from above. FIG. 6 is a diagram showing the upper reagent depository 204 and the lower reagent depository 205 as viewed from the side.

A bar code for identifying a reagent to be stored is attached to each of the reagent containers 101 stored in the upper reagent depository 204 and the lower reagent depository 205. The bar code 102 is an optical mark obtained by encoding identification information of a reagent to be stored in the corresponding reagent container 101, a patient ID, etc. As shown in FIG. 6, an upper reader 231 configured to read a bar code 102 of the reagent container 101 held in the upper reagent depository 204 and a lower reader 232 configured to read the bar code 102 of the reagent container 101 held in the lower reagent depository 205 are provided in the vicinity of the upper reagent depository 204 and the lower reagent depository 205. The upper reader 231 and the lower reader 232 are each a bar code reader capable of reading the bar code 102. The upper reader 231 and the lower reader 232 each output information on a read bar code (bar code information) to the control circuit 9.

Meanwhile, what is affixed to the reagent container 101 is not limited to a bar code. For example, instead of the bar code 102, a mark obtained by encoding identification information of a reagent, etc., an optical mark such as a one-dimensional pixel code or a two-dimensional pixel code, or an IC tag used for Radio Frequency Identification (RFID), etc., may be affixed. Furthermore, instead of the bar code reader, a sensor used for RFID may be used. The bar code 102 of the reagent container 101 held in the upper reagent depository 204 is one example of the first identification information, and the bar code 102 of the reagent container 101 held in the lower reagent depository 205 is one example of the second identification information. The upper reader 231 is one example of the first reader, and the lower reader 232 is one example of the second reader.

In response to an instruction for starting reading of an ID from the control circuit 9, each of the upper reader 231 and the lower reader 232 starts reading the corresponding bar code 102. Upon arrival of the reagent container 101 at a position at which the bar code 102 is readable, each of the upper reader 231 and the lower reader 232 reads identification information of a reagent from the bar code 102 concerned. The upper reader 231 and the lower reader 232 each supply the read identification information to the control circuit 9.

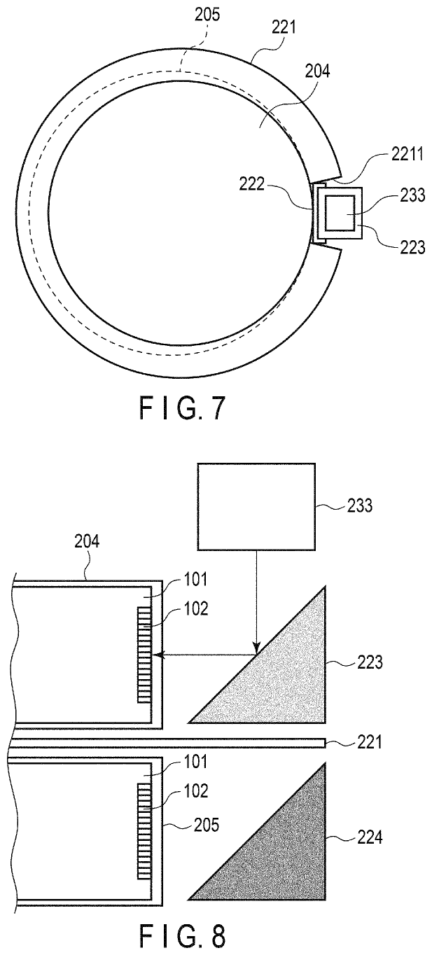

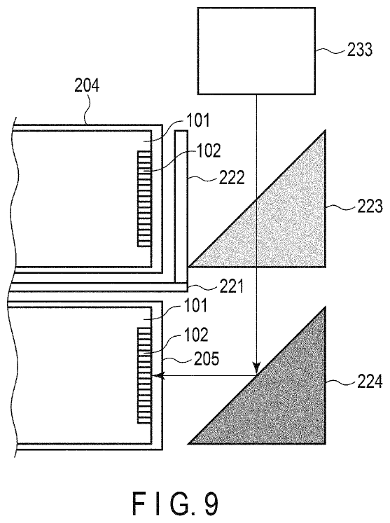

FIG. 5 and FIG. 6 each describe a case in which the plurality of bar code readers (231 and 232) respectively corresponding to the upper reagent depository 204 and the lower reagent depository 205 are provided; however, a common reader which corresponds to both the upper reagent depository 204 and the lower reagent depository 205 may be used as shown in FIG. 7 to FIG. 9. FIG. 7 is a diagram showing the upper reagent depository 204 and the lower reagent depository 205 according to a present modification, as viewed from above. FIG. 8 and FIG. 9 are each a diagram showing the upper reagent depository 204 and the lower reagent depository 205 according to the present modification, as viewed from the side.

In the present modification, a common reader 233 corresponding to both of the upper reagent depository 204 and the lower reagent depository 205 is provided at a reading position. The common reader 233 is a bar code reader configured to read the bar codes 102 at both the upper reagent depository 204 and the lower reagent depository 205. The common reader 233 is installed above the upper reagent depository 204 and the lower reagent depository 205. An upper mirror 223 is installed at the same height as that of the upper reagent depository 204, and a lower mirror 224 is installed at the same height as that of the lower reagent depository 205.

The upper mirror 223 is a half mirror for switching between a state in which the bar codes 102 at the upper reagent depository 204 are readable by the common reader 233 and a state in which the bar codes 102 at the lower reagent depository 205 are readable by the common reader 233. Incident light partially reflects off and partially transmits through the upper mirror 223. The upper mirror 223 is arranged on the lower side of the common reader 233 and is arranged such that a mirror surface thereof faces toward the upper reagent depository 204 and the upper side. The upper mirror 223 is arranged at a position at which the bar codes 102 at the upper reagent depository 204 are readable by the common reader 233.

Incident light fully reflects off the lower mirror 224. The lower mirror 224 is arranged such that its mirror surfaces face toward the lower reagent depository 205 and upward. The lower mirror 224 is arranged on the lower side of the upper mirror 223 and the common reader 233. The lower mirror 224 is arranged at a position at which the bar codes 102 at the lower reagent depository 205 are readable by the common reader 233.

A light shielding plate 221 is provided between the upper reagent depository 204 and the lower reagent depository 205. The light shielding plate 221 is a plate formed into a disk shape and having a light shielding performance. The drive mechanism 4 causes the light shielding plate 221 to rotate about the rotation axis. The light shielding plate 221 includes a cutout part (slit) 2211. The cutout part 2211 is provided on the outer peripheral side of the light shielding plate 221 and is changed in position by the rotation of the light shielding plate 221. FIG. 7 and FIG. 9 each show a state in which the cutout part 2211 is at a reading position. FIG. 8 shows a state in which the cutout part 2211 is at a position other than the reading position.

Furthermore, a light shielding shutter 222 is attached to the cutout part 2211. The light shielding shutter 222 is attached such that it is inserted between the upper mirror 223 and the upper reagent depository 204 in a state in which the cutout part 2211 is at the reading position, as shown in FIG. 9.

In a case of reading the bar code 102 at the upper reagent depository 204, the cutout part 2211 is moved to a position different from the reading position by the drive mechanism 4 rotating the light shielding plate 221. In such a state, as shown in FIG. 8, the light shielding plate 221 is arranged between the upper mirror 223 and the lower mirror 224, so that the common reader 233 cannot read the bar code 102 at the lower reagent depository 205 and can read the bar code 102 at the upper reagent depository 204 reflected off the upper mirror 223.

On the other hand, in a case of reading the bar code 102 at the lower reagent depository 205 as shown in FIG. 7, the cutout part 2211 is moved to the reading position by the drive mechanism 4 rotating the light shielding plate 221. In this state, as shown in FIG. 9, the light shielding plate 221 moves from between the upper mirror 223 and the lower mirror 224, and the light shielding shutter 222 moves to between the upper mirror 223 and the upper reagent depository 204. Therefore, the common reader 233 cannot read the bar code 102 at the upper reagent depository 204 and can read the bar code 102 at the lower reagent depository 205, which has reflected off the lower mirror 224 and has transmitted through the upper mirror 223.

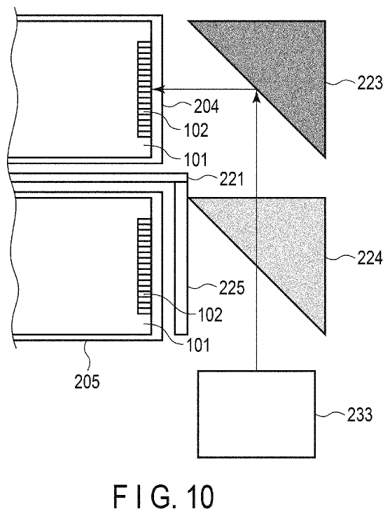

Meanwhile, FIG. 7 and FIG. 9 describe the case in which the common reader 233 is arranged above the upper reagent depository 204 and the lower reagent depository 205; however, the common reader 233 may be arranged on the lower side of the upper reagent depository 204 and the lower reagent depository 205, as shown in FIG. 10. In this case, a mirror configured to reflect the entirety of incident light is arranged as the upper mirror 223, and a half mirror is arranged as the lower mirror 224. The upper mirror 223 and the lower mirror 224 are arranged such that their mirror surfaces face toward the reagent depository and the lower side.

In a case of reading the bar code 102 at the lower reagent depository 205, the light shielding plate 221 is arranged between the upper mirror 223 and the lower mirror 224 in a similar manner to FIG. 8. The common reader 233 cannot read the bar code 102 at the upper reagent depository 204 and can read the bar code 102 at the lower reagent depository 205, which has reflected off the lower mirror 224.

On the other hand, in a case of reading the bar code 102 at the upper reagent depository 204, as shown in FIG. 10, the light shielding shutter 225 is moved to between the lower mirror 224 and the lower reagent depository 205. The common reader 233 cannot read the bar code 102 at the lower reagent depository 205 and can read the bar code 102 at the upper reagent depository 204, which has reflected off the upper mirror 223 and has transmitted through the lower mirror 224.

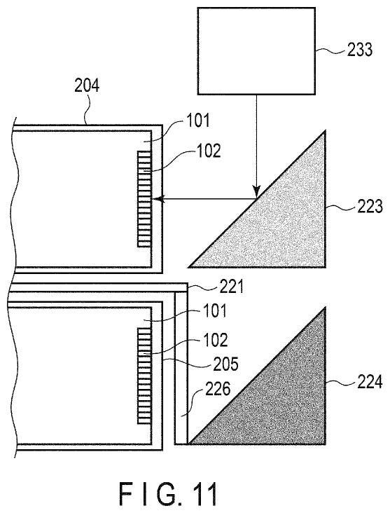

Furthermore, instead of the light shielding plate 221 such as is shown in FIG. 7 to FIG. 9, only the light shielding shutter 226 such as is shown in FIG. 11 may be used. FIG. 11 is a diagram showing the upper reagent depository 204 and the lower reagent depository 205 according to the present modification, as viewed from the side. By the drive mechanism 4, the light shielding shutter 226 is insertably attached between the lower mirror 224 and the lower reagent depository 205 at the reading position. FIG. 11 shows a state in which the bar code 102 at the upper reagent depository 204 is read.

In a case of reading the bar code 102 at the upper reagent depository 204, as shown in FIG. 11, the light shielding shutter 226 is inserted between the lower mirror 224 and the lower reagent depository 205. In this state, the common reader 233 cannot read the bar code 102 at the lower reagent depository 205 and can read the bar code 102 at the upper reagent depository 204, which has reflected off the upper mirror 223.

On the other hand, in a case of reading the bar code 102 at the lower reagent depository 205, the light shielding shutter 226 is moved from between the lower mirror 224 and the lower reagent depository 205, and in a similar manner to FIG. 9, the light shielding shutter 225 is inserted between the upper mirror 223 and the upper reagent depository 204. Therefore, the common reader 233 cannot read the bar code 102 at the upper reagent depository 204 and can read the bar code 102 at the lower reagent depository 205, which has reflected off the lower mirror 224 and has transmitted through the upper mirror 223.

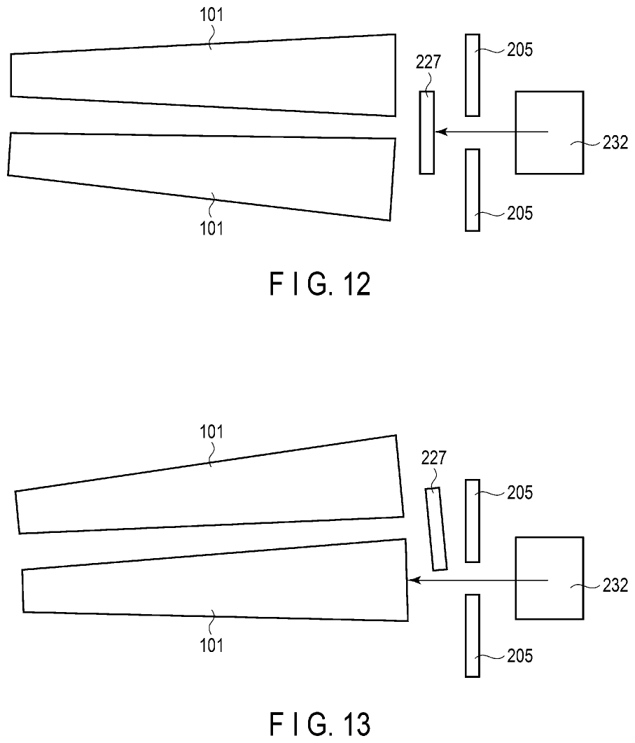

Furthermore, instead of the light shielding plate 221 in FIG. 5 and FIG. 6, a light shielding plate 227 may be arranged inside the lower reagent depository 205 as shown in FIG. 12 and FIG. 13. FIG. 12 and FIG. 13 are each a diagram showing the lower reagent depository 205 according to the present modification, as viewed from above. The light shielding plate 227 is a plate having a light shielding performance. By the drive mechanism 4, the light shielding plate 227 is insertably attached between the reagent container 101 and a side wall of the lower reagent depository 205 at the reading position. FIG. 12 shows a state in which the bar code 102 at the upper reagent depository 204 is read. FIG. 13 shows a state in which the bar code 102 at the lower reagent depository 205 is read.

In a case of reading the bar code 102 at the upper reagent depository 204, as shown in FIG. 12, the light shielding plate 227 is inserted between the reagent container 101 and an inner wall of the lower reagent depository 205 at the reading position. In this state, the lower reader 232 cannot read the bar code 102 of the reagent container 101 within the lower reagent depository 205 and can read the bar code 102 at the upper reagent depository 204, which has reflected off the upper mirror 223.

On the other hand, in a case of reading the bar code 102 at the lower reagent depository 205, as shown in FIG. 13, the light shielding plate 227 moves from between the reagent container 101 and the inner wall of the lower reagent depository 205 at the reading position, and in a similar manner to FIG. 9, the light shielding plate is inserted between the upper mirror 223 and the upper reagent depository 204. Therefore, the lower reader 232 cannot read the bar code 102 at the upper reagent depository 204 and can read the bar code 102 at the lower reagent depository 205, which has reflected off the lower mirror 224 and has transmitted through the upper mirror 223.

In the following description, advantageous effects of the automatic analyzing apparatus 1 according to the present embodiment will be described.

The automatic analyzing apparatus 1 according to the present embodiment includes a plurality of reagent storage parts arranged at different positions in the vertical direction. Specifically, the automatic analyzing apparatus 1 includes the upper reagent depository 204 and the lower reagent depository 205, and the lower reagent depository 205 is arranged on the lower side of the upper reagent depository 204. The upper reagent depository 204 is one example of the first reagent storage part, and the lower reagent depository 205 is one example of the second reagent storage part. Furthermore, the upper reagent depository 204 is smaller in diameter than the lower reagent depository 205. Yet further, the upper reagent depository 204 is arranged within a range of a region in which the lower reagent depository 205 is arranged in the horizontal direction. Therefore, the entire region of the upper reagent depository 204 overlaps the lower reagent depository 205 in the vertical direction. A portion of the lower reagent depository 205 overlaps the upper reagent depository 204 in the vertical direction. That is, the upper reagent depository 204 includes the overlapping region 2045 that overlaps the lower reagent depository 205, and the lower reagent depository 205 includes the overlapping region 2055 that overlaps the upper reagent depository 204.

The above configuration enables the automatic analyzing apparatus 1 according to the present embodiment to ensure, by the two-stage configuration in the vertical direction for the reagent depository, securing of the amount of reagent holdable by the entire reagent depository and decreasing of the diameter and footprint of the entire reagent depository. In this manner, the footprint (area) of the analysis mechanism 2 and the automatic analyzing apparatus 1 can be decreased. Furthermore, the upper reagent depository 204 and the lower reagent depository 205 can be arranged freely because their centers do not need to be at the same positions.

Also, in the present embodiment, the non-overlapping region 2056 not overlapping the upper reagent depository 204 is provided in the lower reagent depository 205 by making the upper reagent depository 204 smaller in diameter than the lower reagent depository 205. The non-overlapping region 2056 is a region above which the upper reagent depository 204 is absent. By providing the non-overlapping region 2056 with the opening 2052 for dispensing, a path for the reagent dispensing probe 211 to access the opening 2052 can be formed without providing the upper reagent depository 204 with a cutout, etc. In this manner, the reagent dispensing probe 211 can perform dispensing on the reagent container 101 within the lower reagent depository 205 without being affected by the operation of the upper reagent depository 204.

Furthermore, the upper reagent depository 204 is provided with the passage region 2043 through which the reagent containers 101 stored in the lower reagent depository 205 are conveyed. In the passage region 2043, internal structures such as the reagent containers 101 are not arranged and a path through which the reagent containers 101 can be conveyed are formed. By utilizing the aforementioned path, the reagent containers 101 held in the lower reagent depository 205 can be carried in or out from the upper side of the lower reagent depository 205.

The reagent containers 101 held in the lower reagent depository 205 may be carried in or out from the side. For example, the side surface of the lower reagent depository 205 is provided with an opening through which the reagent containers 101 can pass. Such a case eliminates the need for the upper reagent depository 204 and the passage region 2043.

### Modification

The present embodiment has described the case in which the reagent depository adopts the two-stage configuration constituted of the upper reagent depository 204 and the lower reagent depository 205; however, the reagent depository may adopt a multi-stage configuration constituted of three or more stages. In such a case also, a dispensing path can be secured by providing a reagent depository arranged on the lower side of another reagent depository with a non-overlapping region not overlapping another reagent depository on the upper side.

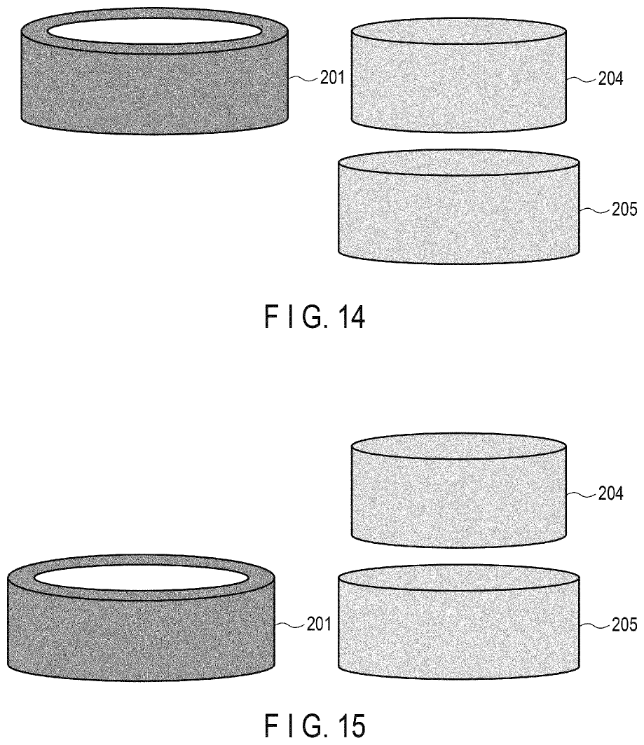

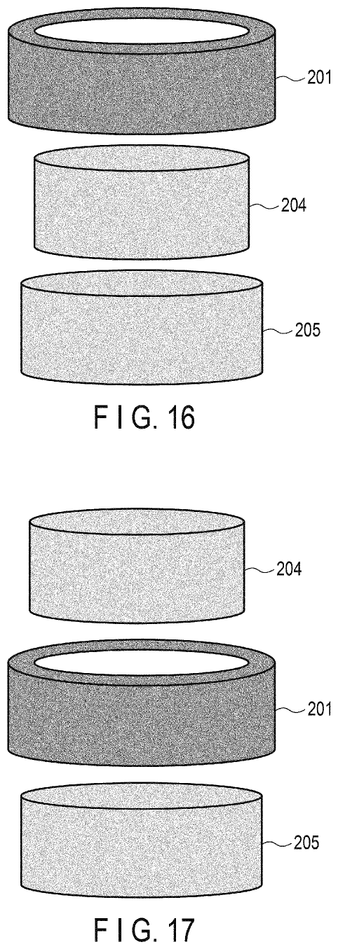

Furthermore, the position of the reagent depository with respect to the reaction disk 201 is not limited. For example, as shown in FIG. 14, the upper reagent depository 204 may be arranged at the same height as that of the reaction disk 201, and the lower reagent depository 205 may be arranged on the lower side of the reaction disk 201. For example, as shown in FIG. 15, the lower reagent depository 205 may be arranged at the same height as that of the reaction disk 201, and the upper reagent depository 204 may be arranged on the upper side of the reaction disk 201. Also, as shown in FIG. 16, both the upper reagent depository 204 and the lower reagent depository 205 may be arranged directly below the reaction disk 201. For example, as shown in FIG. 17, the upper reagent depository 204 and the lower reagent depository 205 may be arranged such that the reaction disk 201 is positioned between the upper reagent depository 204 and the lower reagent depository 205.

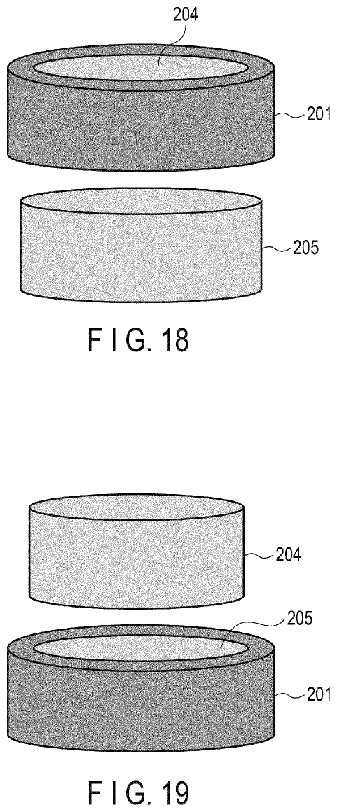

Also, as shown in FIG. 18, the upper reagent depository 204 may be arranged inside the reaction disk 201 and the lower reagent depository 205 may be arranged on the lower side of the upper reagent depository 204 and the reaction disk. As shown in FIG. 19, the lower reagent depository 205 may be arranged inside the reaction disk 201 and the upper reagent depository 204 may be arranged on the upper side of the lower reagent depository 205 and the reaction disk 201.

Also, in the present embodiment, the non-overlapping region 2056 is formed in the lower reagent depository 205 by making the upper reagent depository 204 smaller in diameter than the lower reagent depository 205; however, the non-overlapping region 2056 may be formed in the lower reagent depository 205 by misaligning the center positions of the upper reagent depository 204 and the lower reagent depository 205. In such a case, the upper reagent depository 204 may be equal in diameter to the lower reagent depository 205, may be smaller in diameter than the lower reagent depository 205, or may be larger in diameter than the lower reagent depository 205.

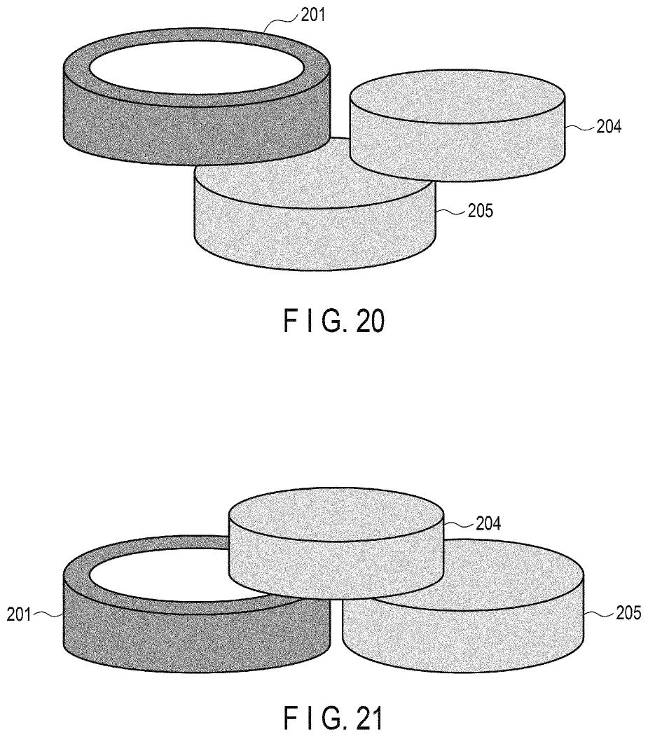

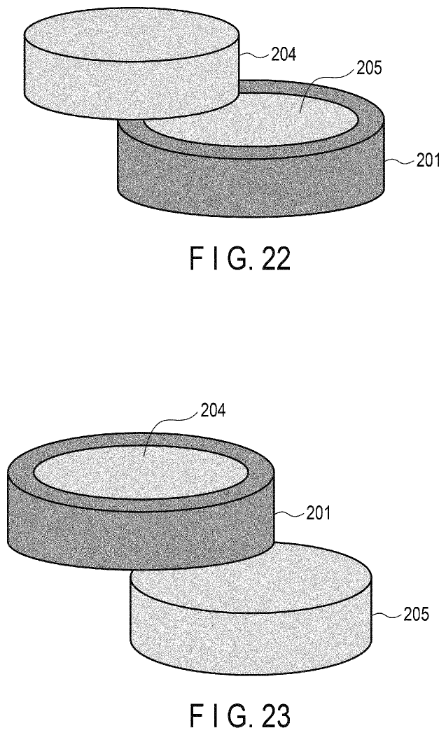

For example, as shown in FIG. 20, both the upper reagent depository 204 and the lower reagent depository 205 may be arranged such that their center positions are different from each other and the lower reagent depository 205 overlaps both the upper reagent depository 204 and the reaction disk 201. For example, as shown in FIG. 21, the upper reagent depository 204 and the lower reagent depository 205 may be arranged such that their center positions are different and the upper reagent depository 204 overlaps both the lower reagent depository 205 and the reaction disk 201. Furthermore, as shown in FIG. 22, the upper reagent depository 204 and the lower reagent depository 205 may be arranged such that their center positions are different from each other, the lower reagent depository 205 is positioned inside the reaction disk 201, and the upper reagent depository 204 overlaps both the lower reagent depository 205 and the reaction disk 201. Furthermore, as shown in FIG. 23, the upper reagent depository 204 and the lower reagent depository 205 may be arranged such that their center positions are different from each other, the upper reagent depository 204 is positioned inside the reaction disk 201, and the lower reagent depository 205 overlaps both the upper reagent depository 204 and the reaction disk 201.

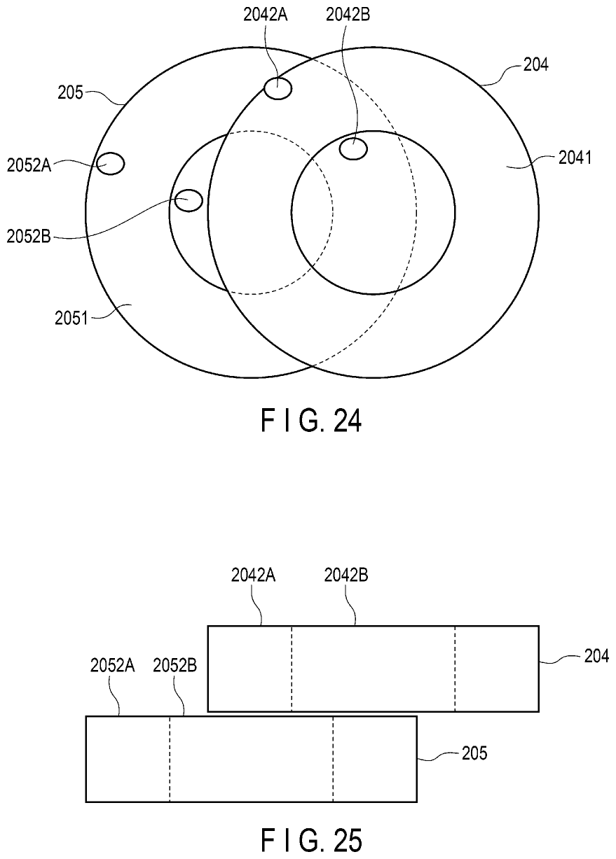

Furthermore, the upper reagent depository 204 or the lower reagent depository 205 may be provided with a plurality of reagent container rows. For example, as shown in FIGS. 24 and 25, each of the upper reagent depository 204 and the lower reagent depository 205 may be provided with a reagent container row on the outer peripheral side in which the reagent containers 101 are arranged in an annular shape along the outer periphery, and a reagent container row on the inner peripheral side in which the reagent containers 101 are arranged in an annular shape along the inside of the reagent container row on the outer periphery side. FIG. 24 is a diagram showing the upper reagent depository 204 and the lower reagent depository 205 according to the present modification as viewed from above. FIG. 25 is a diagram showing the upper reagent depository 204 and the lower reagent depository 205 according to the present modification, as viewed from the side.

The reagent cover 2041 is provided with an opening 2042A through which the reagent dispensing probe 211 passes when dispensing is performed on the reagent container row on the outer peripheral side, and an opening 2042B through which the reagent dispensing probe 211 passes when dispensing is performed on the reagent container row on the inner peripheral side. The reagent cover 2051 is provided with an opening 2052A through which the reagent dispensing probe 211 passes when dispensing is performed on the reagent container row on the outer peripheral side, and an opening 2052B through which the reagent dispensing probe 211 passes when dispensing is performed on the reagent container row on the inner peripheral side. The opening 2052A and the opening 2052B at the lower reagent depository 205 are arranged in the non-overlapping region directly above which the upper reagent depository 204 does not overlap.

In a case of any of FIG. 15 to FIG. 23, a dispensing path can be secured by providing a reagent depository arranged on the lower side of another reagent depository with a non-overlapping region not overlapping another reagent depository on the upper side.

Furthermore, the upper reagent depository 204 may have a structure such a hole or a hollow thorough which the reagent dispensing probe 211 passes to dispense a reagent in the lower reagent depository 205. Thus, a non-overlapping region not overlapping the upper reagent depository 204 can be arranged on the lower reagent depository 205. In such a case, the upper reagent depository 204 may be equal in diameter to the lower reagent depository 205, may be smaller in diameter than the lower reagent depository 205, or may be larger in diameter than the lower reagent depository 205.

Furthermore, as the reader for reading the optical mark attached to the reagent container 101, a dedicated reader (231, 232) provided for each of the upper reagent depository 204 and the lower reagent depository 205 may be used as shown in FIG. 5 and FIG. 6, or a common reader (233) for reading optical marks at both the upper reagent depository 204 and the lower reagent depository 205 may be used as shown in FIG. 7 to FIG. 9.

In a case where the dedicated reader (231, 232) provided for each of the upper reagent depository 204 and the lower reagent depository 205 is provided as shown in FIG. 5 and FIG. 6, the reading operation on the upper reagent depository 204 and the reading operation on the lower reagent depository 205 can be executed in parallel, so that a reading time can be shortened. In a case where the common reader (233) is provided as shown in FIG. 7 to FIG. 9, the number of readers and the number of components connected to readers can be decreased.

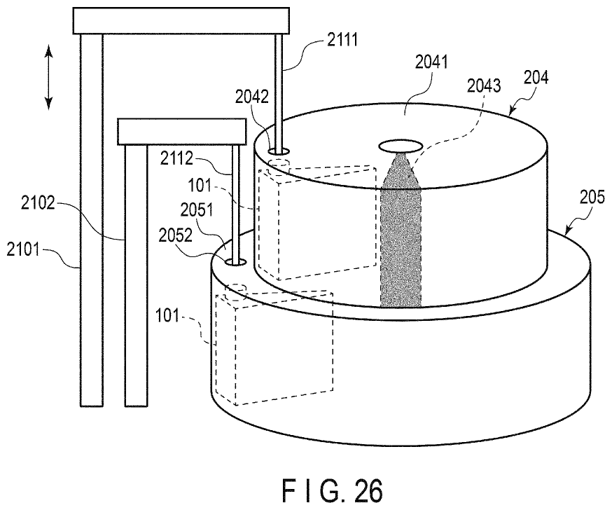

Furthermore, the present embodiment has described the case in which dispensing is executed on both of the upper reagent depository 204 and the lower reagent depository 205 using the common reagent dispensing probe 211 as shown in FIG. 4; however, each of the upper reagent depository 204 and the lower reagent depository 205 may be provided a dedicated reagent dispensing probe. For example, as FIG. 26 shows as the modification of the dispensing means, an upper dispensing probe 2111 configured to dispense reagent into the upper reagent depository 204, an upper dispensing arm 2101 configured to hold the upper dispensing probe 2111, a lower dispensing probe 2112 configured to dispense reagent into the lower reagent depository 205, and a lower dispensing arm 2102 configured to hold the lower dispensing probe 2112 may be provided. The upper dispensing probe 2111 is one example of the first reagent dispensing probe, and the lower dispensing probe 2112 is one example of the second reagent dispensing probe.

In a case where the common dispensing probe (211) is provided as shown in FIG. 4, the number of required reagent dispensing probes and the number of reagent dispensing arms for holding the reagent dispensing probes can be decreased. In a case where the dedicated reader (2111, 2112) is provided for each of the upper reagent depository 204 and the lower reagent depository 205 as shown in FIG. 26, the dispensing operation on the upper reagent depository 204 and the dispensing operation on the lower reagent depository 205 can be executed in parallel, so that a time required to perform the dispensing operation can be shortened.

According to at least one of the embodiments described in the above, the amount of reagent holdable by the reagent depository can be secured while the footprint of the automatic analyzing apparatus can be decreased.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An automatic analyzing apparatus comprising a plurality of reagent storage parts configured to hold reagent containers and arranged at different positions in a vertical direction,
wherein a respective one of the plurality of reagent storage parts includes an overlapping region overlapping another one of the reagent storage parts in the vertical direction.

2. The automatic analyzing apparatus according to claim 1, wherein
the plurality of reagent storage parts include a first reagent storage part arranged on an upper side and a second reagent storage part arranged on a lower side of the first reagent storage part, and
the first reagent storage part and the second reagent storage part are formed such that a reagent container stored in the second reagent storage part is accessible.

3. The automatic analyzing apparatus according to claim 2, wherein the second reagent storage part includes a non-overlapping region not overlapping the first reagent storage part in the vertical direction.

4. The automatic analyzing apparatus according to claim 2, wherein the first reagent storage part and the second reagent storage part are arranged at different positions in a horizontal direction.

5. The automatic analyzing apparatus according to claim 4, wherein a central position of the first reagent storage part and a central position of the second reagent storage part are arranged at different positions in the horizontal direction.

6. The automatic analyzing apparatus according to claim 2, wherein the first reagent storage part is smaller in diameter than the second reagent storage part.

7. The automatic analyzing apparatus according to claim 2, further comprising:
a first reader configured to read first identification information attached to the first reagent storage part; and
a second reader configured to read second identification information attached to the second reagent storage part.

8. The automatic analyzing apparatus according to claim 2, further comprising:
a reader configured to read both first identification information attached to the first reagent storage part and second identification information attached to the second reagent storage part; and
a half mirror for switching between a state in which the first identification information is readable by the reader and a state in which the second identification information is readable by the reader.

9. The automatic analyzing apparatus according to claim 2, wherein the second reagent storage part has an upper surface including an opening through which the reagent container passes.

10. The automatic analyzing apparatus according to claim 9, wherein the first reagent storage part includes a passage region through which the reagent container to be stored in the second reagent storage part is able to pass.

11. The automatic analyzing apparatus according to claim 2, wherein the second reagent storage part has a side surface including an opening through which the reagent container passes.

12. The automatic analyzing apparatus according to claim 2, further comprising:
a first reagent dispensing probe configured to dispense a reagent of the first reagent storage part; and
a second reagent dispensing probe configured to dispense a reagent of the second reagent storage part.

13. The automatic analyzing apparatus according to claim 2, further comprising a reagent dispensing probe configured to dispense both a reagent of the first reagent storage part and a reagent of the second reagent storage part.
